(19) United States
(12) Patent Application Publication
(10) Pub. No.: US 2013/0278737 A1
(43) Pub. Date: Oct. 24, 2013

(54) Infotainment System

(71) Applicant: Bayerische Motom Werke Aktiengesellschaft, Muenchen (DE)

(72) Inventors: Robert ISELE, Fuerstenfeldbruck (DE); Thilo BAUR, Augsburg (DE)

(21) Appl. No.: 13/919,584

(22) Filed: Jun. 17, 2013

Related U.S. Application Data
(63) Continuation of application No. PCT/EP2011/071371, filed on Nov. 30, 2011.

(30) Foreign Application Priority Data
Dec. 17, 2010 (DE) 10 2010 063 367.4

(51) Int. Cl. H04N 7/18

(52) U.S. Cl. CPC H04N 7/18
USPC 348/61

(57) ABSTRACT

An infotainment system has a control unit and a processing unit coupled to each other by a data connection. The processing unit converts predetermined infotainment data, which are present in a first data format, at least partially into a second, uncompressed data format. The processing unit makes the converted infotainment data in the second, uncompressed data format available to the control unit by way of the data connection. The control unit receives the infotainment data in the second, uncompressed data format and combines with additional predetermined infotainment data, which are present in the second, predetermined data format, and provides the combined infotainment data at least partially for display on at least one display unit associated with the control unit.

### CROSS REFERENCE TO RELATED APPLICATIONS

This application is a continuation of PCT International Application No. PCT/EP2011/071371, filed Nov. 30, 2011, which claims priority under 35 U.S.C. §119 from German Patent Application No. DE 10 2010 063 367.4, filed Dec. 17, 2010, the entire disclosures of which are herein expressly incorporated by reference.

### BACKGROUND AND SUMMARY OF THE INVENTION

The invention relates to an infotainment system and, in particular, to an infotainment system for motor vehicles having a control unit and a processing unit.

Infotainment systems are regularly used in motor vehicles in order to permit, for example, a display of preset infotainment data on a video screen. In this case, a video screen may be arranged, for example, in a center console or in a dashboard of the motor vehicle and be controlled by way of the infotainment system for the display of infotainment data.

It is an object of the invention to create an infotainment system that permits a display of infotainment data that is as simple and as cost-effective as possible.

This and other objects are achieved according to the invention by an infotainment system which comprises a control unit and a processing unit. The control unit and the processing unit are mutually coupled by way of a data connection. The processing unit is designed for converting preset infotainment data, which are available in a first data format, at least partially to a second uncompressed data format and for providing the converted infotainment data in the second uncompressed data format by way of the data connection to the control unit. The control unit is designed for receiving the infotainment data in the second uncompressed data format and for combining the received infotainment data with additional preset infotainment data which are available in the second preset data format. The control unit is further designed for providing the combined infotainment data at least partially for a display on at least one display unit assigned to the control unit.

An infotainment system of this type has the advantage that no high-performance control unit is required for a display of infotainment data on the assigned display unit. The infotainment data are provided by the processing unit already in the second uncompressed data format. The infotainment data in the second uncompressed data format are preferably already suitable for the display by the display unit. A decompression and/or processing of infotainment data can therefore preferably be eliminated on the part of the control unit. It is therefore preferably sufficient for the processing unit to be constructed to be correspondingly powerful to implement the conversion of the preset infotainment data to the second uncompressed data format. As a result, the demand for high-performance control devices in the motor vehicle can be reduced, whereby a cost-effective infotainment system can be implemented.

The processing unit can be coupled with additional control units and be designed to provide the additional control units with infotainment data in the second uncompressed data format. In this case, identical or different uncompressed infotainment data may be made available to the respective control units.

The processing unit and the control unit may each be designed as a modular unit which are arranged separately of one another. The infotainment system is preferably arranged in a motor vehicle. The control unit and the processing unit may, for example, each be designed as a control device and each form separate modular units. In this case the control unit and the processing unit may be arranged in a distributed manner.

The data connection is designed for transmitting infotainment data in the second uncompressed data format at a sufficient transmission speed between the processing unit and the control unit, so that a corresponding display by a display unit becomes possible.

The combining of the additional preset infotainment data and of the received infotainment data may, for example, include an adding of the additional preset infotainment data to the infotainment data provided by the processing unit or vice versa.

In an advantageous development, the processing unit is designed for providing at least partially the infotainment data in the second uncompressed data format for a display on at least one additional display unit assigned to the processing unit. This permits a display of infotainment on several display units, in which case the infotainment data to be displayed on the different display units are preferably correspondingly converted to the second uncompressed data format only by the processing unit. The infotainment data provided to the display units may be identical or different.

In a further advantageous development, the infotainment data preset for the processing unit, which are available in a first data format, are designed as analog data. The preset infotainment data may be available, for example, as a color video blanking signal. The infotainment data converted by the processing unit are preferably provided as digital data. As an alternative, the infotainment data preset for the processing unit, which are available in the first data format, may be designed as uncompressed or compressed digital data.

In a further advantageous development, the preset infotainment data include video and/or audio data. The preset infotainment data preferably comprise video data. As an alternative or in addition, the infotainment data may also comprise audio data. In a particularly simple manner, this makes it possible to provide video and/or audio data as infotainment data to the control unit. In this case, the display unit assigned to the control unit is preferably designed as a video screen and/or loudspeaker. The additional preset infotainment data of the control unit may, for example, represent an instrument display of the motor vehicle, such as a speed and/or rotational speed display. The received infotainment data may, for example, represent a display of a navigation application. By means of the control unit, the received infotainment data in the second uncompressed data format are combined with the additional preset infotainment data to a combined presentation. This combined presentation may be shown on the display unit assigned to the control unit, which display unit includes, for example, a video screen in the instrument panel of the motor vehicle, as an instrument view with an integrated navigation application. As a result, a mixed representation of infotainment data of different data sources can be implemented particularly easily.

In a further advantageous development, the processing unit and the control unit are designed to exchange, by way of the data connection, control data, in addition to the infotainment data in the second uncompressed data format. By means of the data connection, the control data can be transmitted preferably bidirectionally between the two units.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a general block diagram view of the display system according to an embodiment of the present invention; and

FIG. 2 is a series of views of a display example according to an embodiment of the present invention.

### DETAILED DESCRIPTION OF THE DRAWINGS

Elements of the same design or function are provided with the same reference symbols in all figures.

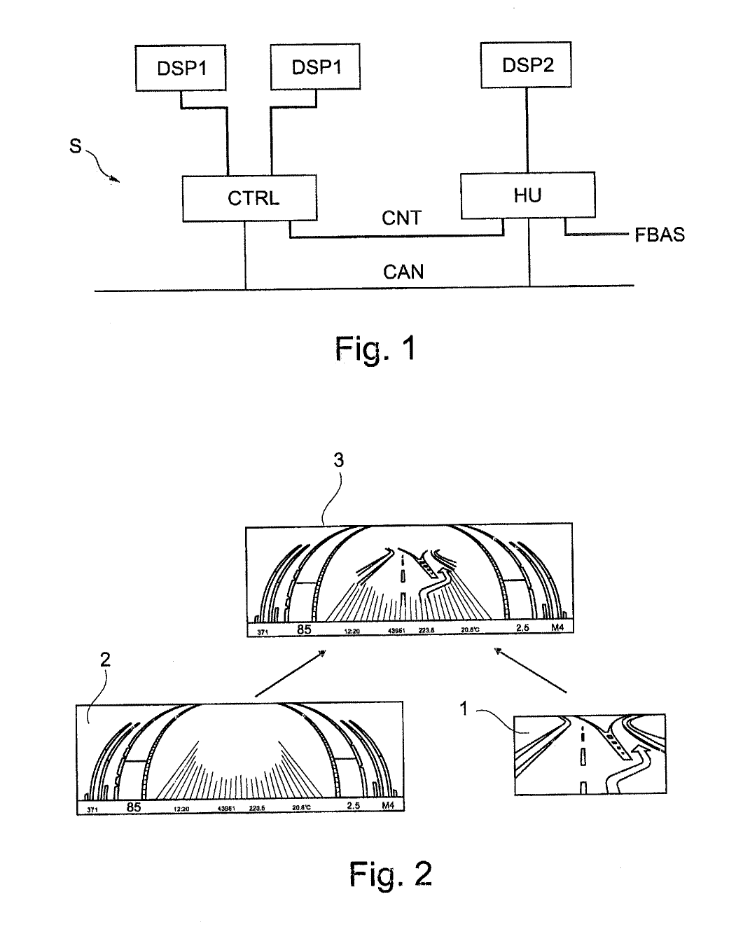

FIG. 1 illustrates an infotainment system S, which includes a processing unit HU and a control unit CTRL.

The infotainment system S is preferably arranged in a motor vehicle and designed for providing occupants of the motor vehicle with infotainment data including, for example, video and/or audio data, by use of a preset user interface.

The processing unit HU is constructed, for example, as a main control unit, which may also be called a head unit. The processing unit HU preferably includes one or more processors, such as graphic processors, which are preferably designed for processing infotainment data. The control unit CTRL is, for example, designed as a modular unit that is separate from the processing unit HU, for example, as a control device for an instrument panel of the motor vehicle. In this case, the processing unit HU and the control unit CTRL are, for example, arranged in the motor vehicle in a distributed manner.

The control unit CTRL is coupled with a first display unit DSP1, which includes, for example, a video screen and/or a loudspeaker. The first display unit DSP1 is assigned, for example, to an instrument panel of a dashboard of a motor vehicle. The control unit CTRL may be coupled with additional first display units DSP1, such as a front view video screen, which may also be called a head-up display. The coupling between the control unit CTRL and the respective display unit DSP1 is designed, for example, as a digital multimedia interface, such as an HDMI or DVI interface. In principle, other, for example, analog interfaces may also be used.

The processing unit HU may be coupled with at least a second display unit DSP2, such as a central video screen in a center console of the motor vehicle. The coupling is preferably designed in an analogous manner with respect to the coupling between the control unit CTRL and the respective first display unit DSP1. The processing unit HU is preferably designed for converting preset infotainment data of a first data format to infotainment data of a second uncompressed data format. For this purpose, the preset infotainment data may be made available on the input side, for example, by way of an analog signal FBAS, which is designed, for example, as a color video blanking signal. As an alternative, the preset infotainment data may also be provided either as uncompressed or compressed data. The processing unit HU may also include at least one memory, in which the preset infotainment data are stored. The preset infotainment data include, for example, multimedia data, such as video data. In principle, the preset infotainment data may also include audio data. For example, the preset infotainment data may be assigned to a navigation application and represent, for example, a preset map section or road section. The processing unit HU is designed, for example, by use of a graphic processor, to convert and provide the preset infotainment data in the first data format to infotainment data of the second uncompressed data format.

The processing unit HU is coupled with the control unit CTRL by a data connection CNT. The data connection CNT is designed for providing the infotainment data in the second uncompressed data format to the control unit CTRL. In this case, the data connection CNT is, for example, designed to transmit the infotainment data at a particularly high transmission speed, thus, for example, between 500 and 3,000 MBit/s, at least unidirectionally over a distance of, for example, up to 12 m, to the control unit CTRL. The data connection CNT may be designed to provide one or more channels for the transmission of infotainment data, particularly of video data in the second uncompressed data format. In addition to the infotainment data in the second uncompressed data format, data can also be transmitted in the compressed form by way of the data connection CNT between the control unit CTRL and the processing unit HU. The data connection CNT can also be designed to transmit, in addition to the infotainment data in the second uncompressed data format, control data, thus, for example, by way of the Ethernet protocol, bidirectionally between the processing unit HU and the control unit CTRL. For example, by way of this control data channel, handshake data and/or status data can be transmitted as control data.

The processing unit HU may also be coupled with additional control units CTRL, which have an analogous design. In this case, the respective control unit CTRL can be coupled directly by way of a further respective data connection CNT with the processing unit HU. However, as an alternative, a coupling is also contemplated between the control units CTRL and the processing unit HU in accordance with a series connection as a so-called daisy chain.

The control unit CTRL is designed for receiving the infotainment data in the second uncompressed data format provided by the processing unit HU and combining the data with further preset infotainment data which are preferably available in the second uncompressed data format. The further preset infotainment data may, for example, be stored in at least one memory of the control unit CTRL. The combining of the infotainment data may include, for example, an adding of the further preset infotainment data to the infotainment data provided by the processing unit HU or vice versa.

The control unit CTRL and the processing unit HU may be further coupled with a data communication system CAN, thus, for example, with a controller area network system, by which control data can also be transmitted.

FIG. 2 illustrates three displays 1-3. A first display 1 is assigned, for example, to a navigation application and displays a representation of a road section. For example, the first display 1 is a result of infotainment data which, by means of the processing unit HU, are provided to the control unit CTRL in the second uncompressed data format. The further preset infotainment data of the control unit CTRL represent, for example, an instrument representation, which is shown in a second display 2, thus, for example, vehicle speed instruments, engine rotational speed instruments, etc. In this case, a preset area of the instrument representation may be reserved, for example for the navigation application. By way of the combination of the received and further preset infotainment data by the control unit CTRL, this preset reserved area is filled by the infotainment data provided by the processing unit HU, so that a third display 3 is obtained which, as a combined or mixed representation, includes the instrument representation as well as the road section. The combining of the infotainment data by the control unit CTRL can take place, for example, by a known layering or texturing process.

### LIST OF REFERENCE SYMBOLS

1-3 Display examples
CAN Data communication system
CNT Data connection
CTRL Control unit
DSP1, DSP2 Display unit
FBAS Analog signal
HU Processing unit
S Infotainment system

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An infotainment system, comprising:
a control unit;
a processing unit;
a data connection mutually coupling the processing unit and the control unit, wherein
the processing unit is operatively configured to convert preset infotainment data available in a first data format at least partially into a second uncompressed data format,
the processing unit is operatively configured to provide the converted infotainment data in the second uncompressed data format to the control unit via the data connection,
the control unit is operatively configured to receive the converted infotainment data in the second uncompressed data format and to combine the received infotainment data with additional preset infotainment data available in the second preset data format, and
the control unit is operatively configured to provide the combined infotainment data for display on at least one display unit assigned to the control unit.

2. The infotainment system according to claim 1,
wherein the processing unit and the control unit are configured as modular units arranged separately from one another.

3. The infotainment system according to claim 1,
wherein the processing unit is operatively configured to provide the infotainment data in the second uncompressed data format for display on a further display unit assigned to the processing unit.

4. The infotainment system according to claim 2,
wherein the processing unit is operatively configured to provide the infotainment data in the second uncompressed data format for display on a further display unit assigned to the processing unit.

5. The infotainment system according to claim 1, wherein the preset infotainment data available in the first data format are analog data.

6. The infotainment system according to claim 1, wherein the preset infotainment data comprise at least one of video and audio data.

7. The infotainment system according to claim 5, wherein the preset infotainment data comprise at least one of video and audio data.

8. The infotainment system according to claim 1, wherein the processing unit and the control unit are configured to exchange, via the data connection, control data in addition to the converted infotainment data in the second uncompressed data format.

9. A method of operating an infotainment system having a control unit and a processing unit mutually coupled via a data connection, the method comprising the acts of:
converting, via the processing unit, preset infotainment data available in a first data format at least partially to a second uncompressed data format;
providing the converted infotainment data in the second uncompressed data format, via the data connection, to the control unit;
receiving, by the control unit, the converted infotainment data in the second uncompressed data format;
combining, in the control unit, the received infotainment data with additional preset infotainment data available in the second preset data format; and
providing the combined infotainment data for display on a display unit assigned to the control unit.

10. The method according to claim 9, further comprising the act of:
providing, by the processing unit, at least partially the infotainment data in the second uncompressed data format for display on a further display unit assigned to the processing unit.

11. The method according to claim 9, further comprising the act of:
exchanging, via the data connection, control data between the processing unit and the control unit in addition to the infotainment data in the second uncompressed data format.

12. The method according to claim 9, wherein the preset infotainment data is analog data.

13. The method according to claim 9, wherein the preset infotainment data is at least one of video and audio data.
